(19) United States
(12) Patent Application Publication
(10) Pub. No.: US 2006/0173731 A1
(43) Pub. Date: Aug. 3, 2006

(54) Method and apparatus for personnel evaluation

(75) Inventor: Henry F. Scarpelli, Oakland, CA (US)

Correspondence Address: Harris Zimmerman;Law Offices of Harris Zimmerman, Suite 710, 1330 Broadway, Oakland, CA, 94612, US

(73) Assignees: Empire Paper Corp. dba; Baron Software Solutions

(21) Appl. No.: 11/050,258

(22) Filed: Feb. 1, 2005

(51) Int. Cl. G06F 11/34

(52) U.S. Cl. 705/11

(57) ABSTRACT

A method and system for facilitating employee evaluations and generating written evaluation reports provides a software application that furnishes a graphical user interface (GUI) for the user, who is typically an administrative reviewer. The software application provides personalized desktop portalling for the reviewer, as well as rubrics and templates for establish evaluation criteria for various positions and job descriptions. It also provides data gathering forms in checklist format, and windows for comments, and are user-modifiable. Report assembly modules generate an evaluation report that includes declarative statements corresponding to the checklist entries as well as seamless inclusion of evaluator comments.

### CROSS-REFERENCE TO RELATED APPLICATIONS

None.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to the task of personnel evaluation in organizational settings and, more particularly, to a method and apparatus for conducting personnel evaluations and generating evaluation reports.

2. Description of Related Art

Most institutions and large businesses have established human resources policies regarding an employee's advancement or promotion in the organization based on periodic reviews of the employee's performance. These reviews are typically used to justify increases in salary or promotion to a new position. They are also required if an employer decides to discipline or terminate an employee's contract, in that such actions should be supported by a written record of the employee's conduct and performance.

In the field of education, many school districts are required to establish accountability standards for students and teachers. The students are tested regularly to determine their mastery of fundamental skills as well as higher level achievement. Determining teachers' performance, however, is not as straightforward. Most school districts are required to evaluate the performance of their teachers on a recurrent basis to assure that the teachers meet the standards and goals set forth by the districts. The performance evaluations may be carried out by school principals, district specialists, or outside consultants. Different reviewers tend to apply different sets of standards, and the results can vary markedly. In addition, evaluation reports may make use of terminology and concepts that are inapt, antiquated, misstated, misapplied, or poorly understood. Given the fact that periodic evaluation reports are so necessary, it is desirable that a uniform and reproducible methodology be used in creating these reports. The prior art is deficient in this regard.

### BRIEF SUMMARY OF THE INVENTION

The present invention generally comprises a method and system for facilitating employee evaluations and generating written evaluation reports. A salient feature of the invention is that it provides uniform and rule-based evaluation criteria and procedures, so that the evaluation process is standardized and thus fair to all employees. In addition, the invention facilitates creating written reports that incorporate concepts and terminology that address explicit standards and criteria by which the evaluations are conducted. Also, the invention provides a web-based data-gathering and storage facility, which provides evaluations based on the most up-to-date personnel data, standards and criteria. The web-based system also enables a reviewer to upload evaluation data frequently, so that the computer used in the evaluation process may be freed of any data or review materials that should remain confidential.

In one aspect, the invention provides a software application that furnishes a graphical user interface (GUI) for the user, who is typically an administrative reviewer. The software application provides personalized desktop portalling for the reviewer, as well as rubrics and templates for establish evaluation criteria for various positions and job descriptions. It also provides data gathering forms in checklist format, and windows for comments. The sequence of screens can follow a branching tree format, or may be selected by the user via pull-down menus and the like. The checklist format and comments windows are user-modifiable and stored, and the data derived from the checklist format and comments are stored. The software includes report assembly modules so that the user's checklist entries and comments are recalled and, based on this information, an evaluation report is generated that includes declarative statements that correspond to the checklist entries and seamless inclusion of comments. Thus the software application not only presents the evaluation criteria and gathers the data, but it also uses the proper terminology and jargon and syntax in assembling the report. In addition, the software asks for the gender of the evaluation subject and reformats the personal pronoun in the report sentences to reflect the correct gender of the subject (she/he, her/his, etc.).

The software application is connected through the internet to databases and information sources that may be extrinsic or intrinsic to the system. For example, it may be connected to human resource information system back end vendors that provide employee records and data concerning compensation and previous evaluations; and to database providers that store evaluation rubrics, templates, previously customized templates, and the like. Alternatively, all of these resources may be located within a single website.

Alternatively, in a stand-alone configuration the various sources are loaded in the reviewer's computer and are directly available to the software application, and the personalized evaluations are conducted and reports written by the software application. This configuration enables the reviewer to develop a satisfactory level of self-service by using an invariant GUI rather that a frequently-updated web interface.

The software application may also be connected to information sources such as intranet or internet reference sites that list and access information regarding further evaluation topics, job descriptions, templates, and the like. This feature enables organizations within the same field to compare and exchange evaluation procedures and rubrics.

### BRIEF DESCRIPTION OF THE DRAWING

FIGS. 1-31 are a sequence of screen shots depicting the program screens that gather data, arrange evaluation meetings, and assemble evaluation reports, in accordance with the method of the invention.

FIG. 32 is a functional block diagram of the apparatus of the invention for conducting personnel evaluations and writing evaluation reports.

FIG. 33 is a block diagram of the system architecture of the apparatus of the invention.

### DETAILED DESCRIPTION OF THE INVENTION

The present invention generally comprises a method and system for facilitating employee evaluations and generating written evaluation reports. Although the drawings and description are directed to an embodiment for evaluations of educational personnel, it may be appreciated that the invention is adaptable to virtually any employee evaluation situation.

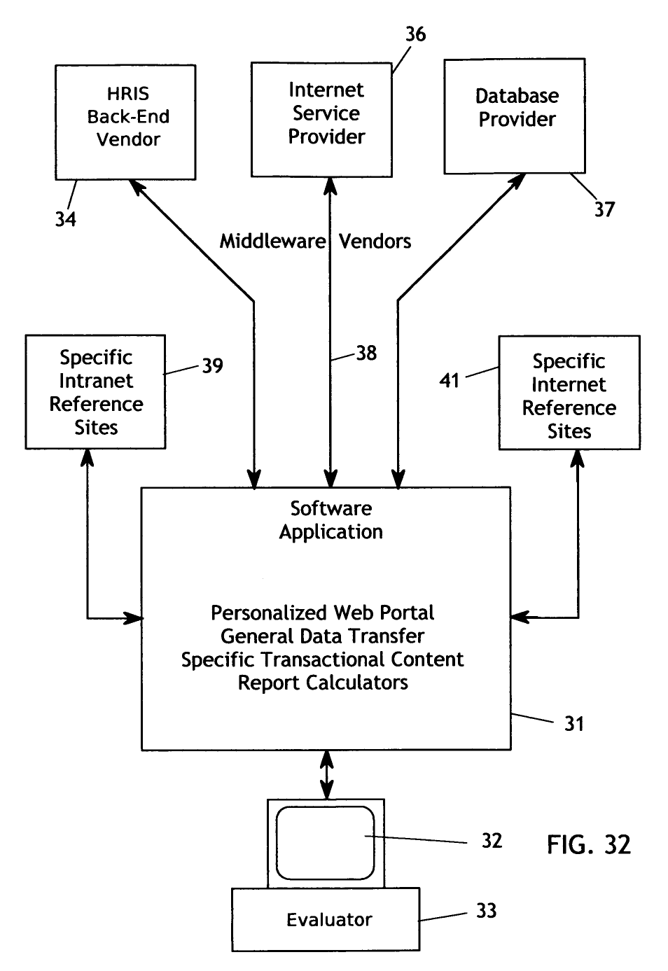

The system is designed to operate on a computer having a central processor, a large permanent memory system, RAM, and a graphical user interface such as Windows or the like. In addition, the computer is provided with some form of input device for navigating and interacting with the GUI, such as a mouse, joystick, pen and touch screen, or the like. With regard to FIG. 32, the system includes a software application 31 that furnishes a GUI for the display 32 of the computer 33 of the evaluator user, who is typically an administrative official of the organization. The software application 31 is connected to databases and information sources that may be internal to the system or extrinsic.

The system software 31 may be operatively connected by buss or network link to human resource information system back end vendors 34 that provide employee records and data concerning compensation and benefits. It may also be connected to internet service providers 36 for access to data sources and storage. The various vendors 34, 36, and 37 may be connected to the software application through middleware vendors 38 that provide personalized employee data, transaction operations, and interactive forms to enable such operations. The software application 31 provides personalized desktop/laptop portalling for the evaluator, as well as general information and data regarding the evaluations, professions, and organizations involved in the personnel evaluations. It also provides report calculators that extract data from evaluation form inputs and screens, and format the data as written paragraphs that include the proper terminology, gender pronouns, and evaluation criteria. In this regard, the software application enables the evaluation reviewer to carry out many functions in standardized formats that formerly were conducted ad hoc. This factor assures that evaluations of a wide range of employees are conducted fairly and uniformly.

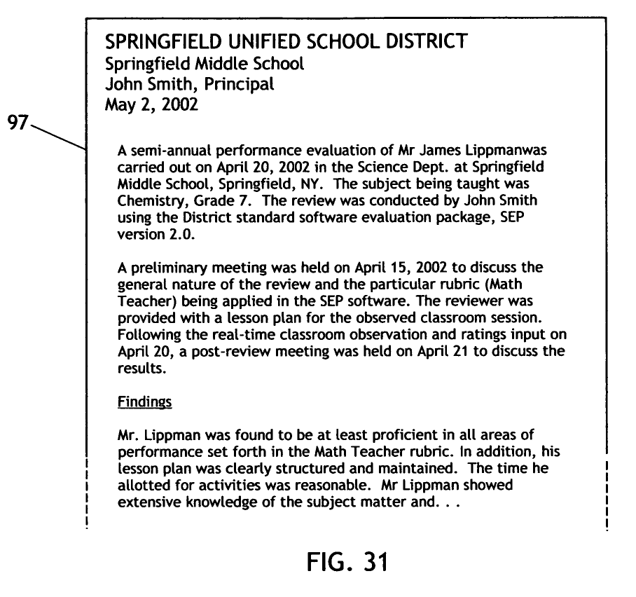

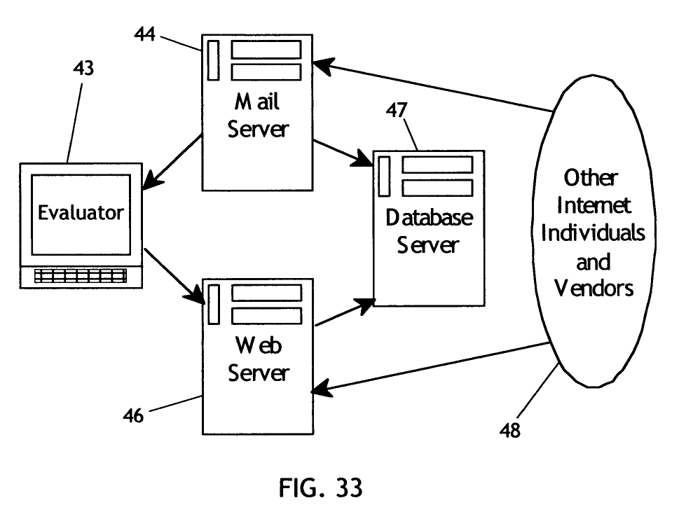

With regard to FIG. 33, the architecture of the system of the invention includes the computer 43 of the evaluator user, which may advantageously comprise a laptop computer having display, keyboard, pointing or navigating device, and some means (wireless transceiver, cable network, etc.) for connecting to the web. Through such connections it is interactive with a mail server 44 and web server 46, and through those facilities it may interact with a database server 47. The individuals and vendors described with reference to FIG. 31 are also connected through the mail server 44 and web server 46 to the evaluator's computer 43.

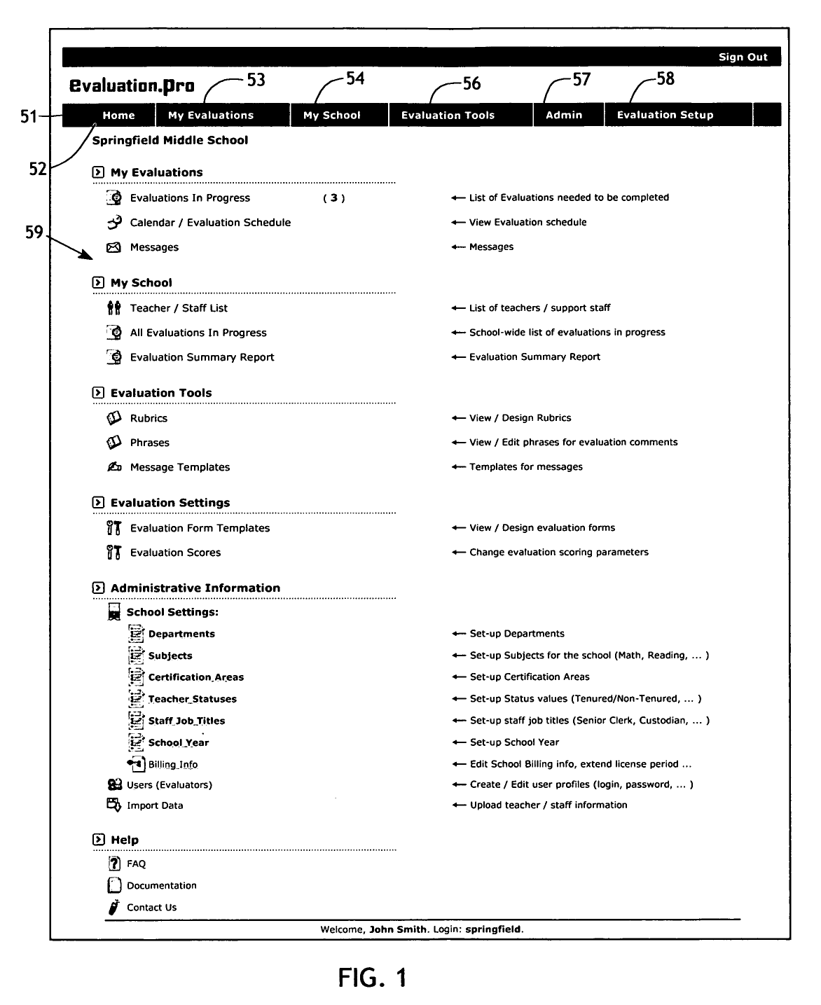

The software application 31 of the invention presents any one of a plurality of display screens or pages to the display 32 of the computer 33 of the evaluator user evaluator user to enable selection of functions, access to menus and information, navigation to particular screens or checklists or forms, and the like. With regard to FIG. 1, a Home screen 50 portrays a series of pull-down menus disposed in lateral array 51, including such menus as Home 52, My Evaluations 53, My School 54, Evaluation Tools 56, Admin 57, and Evaluation Setup 58. These menu headings are also depicted on the home screen in outline format 59, so that major branching categories under each menu topic is depicted as well by icon and labeling, whereby the evaluator/user may navigate to any major category directly. To further this access, each icon may be set up as a hot button that enables a direct click-through to the screen associated with the icon that is clicked. Although these screens or pages may be accessed in any order, they will be described in their vertical outline order as shown in FIG. 1.

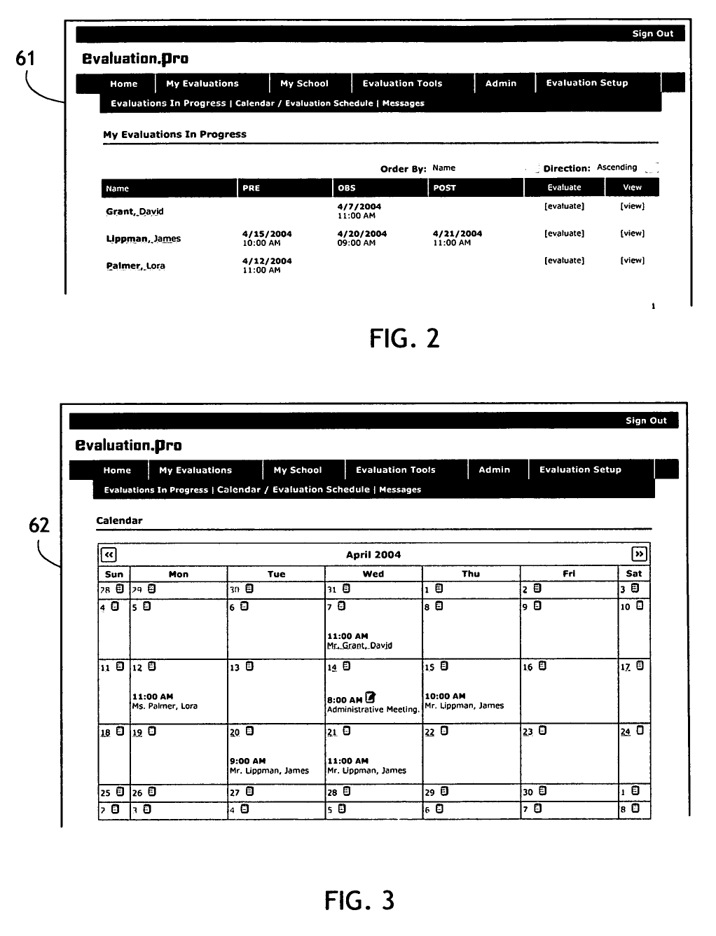

The first page accessed in the My Evaluations menu 53 is Evaluations in Progress, an example of which is shown in FIG. 2. This page 61 lists evaluations by the name of the subject, and includes columns for entering data for scheduling a pre-observation contact meeting, observation meeting, post-observation follow-up meeting, as well as evaluate and view columns for direct access to the latest inputs. This data may also be displayed and entered in a calendar/evaluation schedule page 62, as shown in FIG. 3, which may be more effective in visualizing appointments and time commitments. The My Evaluations menu also includes a message page (not shown) that may be any convenient or familiar form of e-mail interactive page.

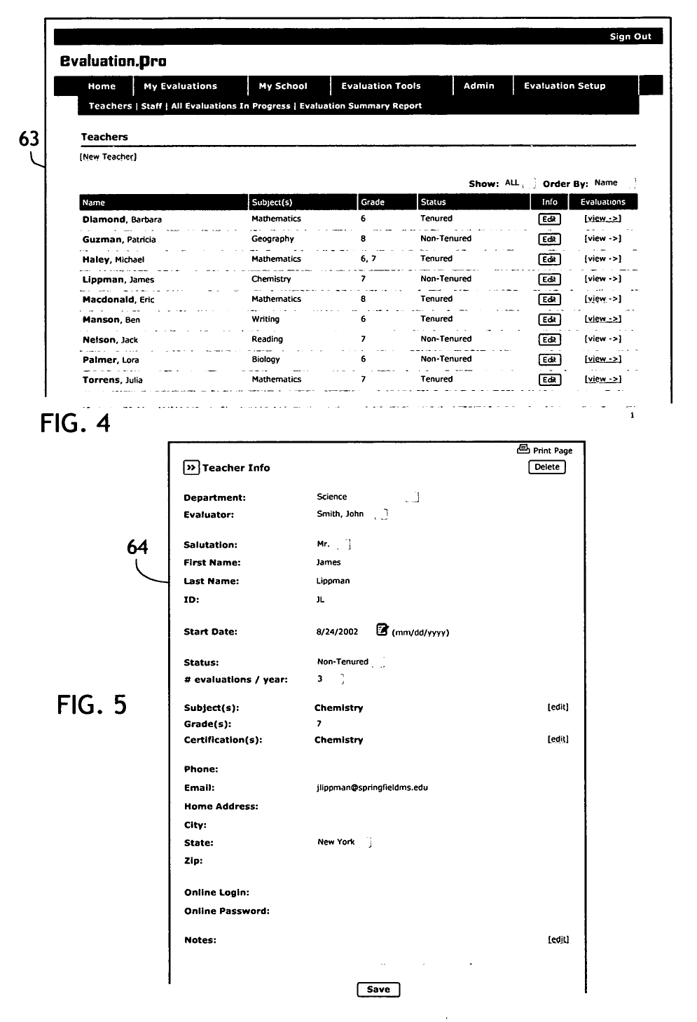

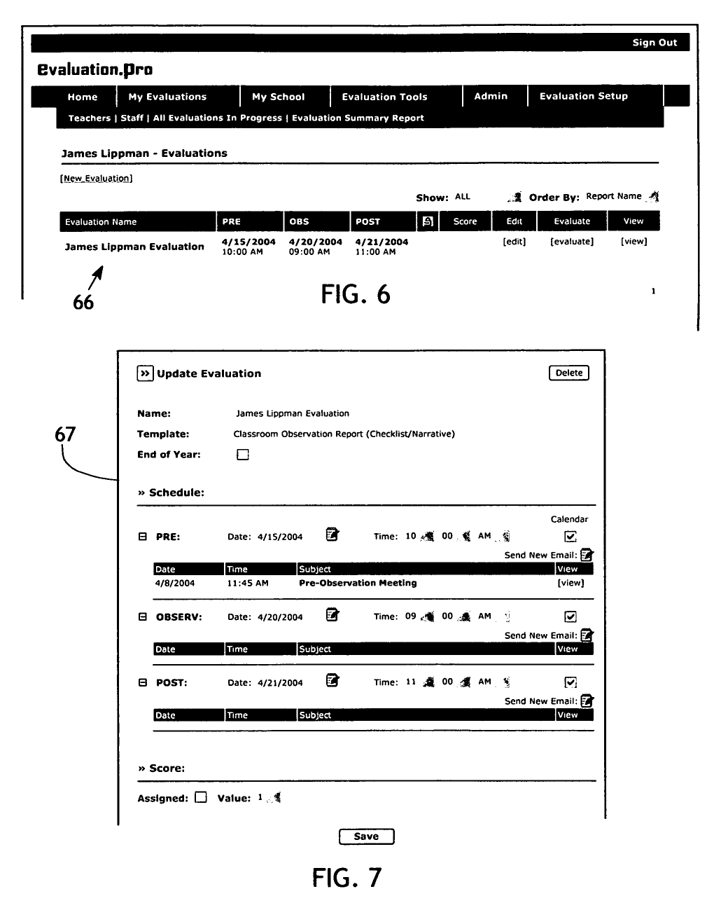

With regard to FIG. 4, the My School menu 54 includes a screen or page 63 that portrays a teacher/staff list. It includes columns for name, subject(s) taught, grade, tenure status, info Edit, and view evaluations. The Edit entry is a hot button that provides a click-through to a data input page 64, an example of which is shown in FIG. 5, that includes active fields for input of the data in any of the columns of screen 63 as well as personal data for the evaluation subject. Another My School menu 54 item is evaluations in progress, which calls forth a screen 66, shown in FIG. 6, that permits display and entry of data for one subject corresponding to the scheduling data columns of screen 61 of FIG. 2.

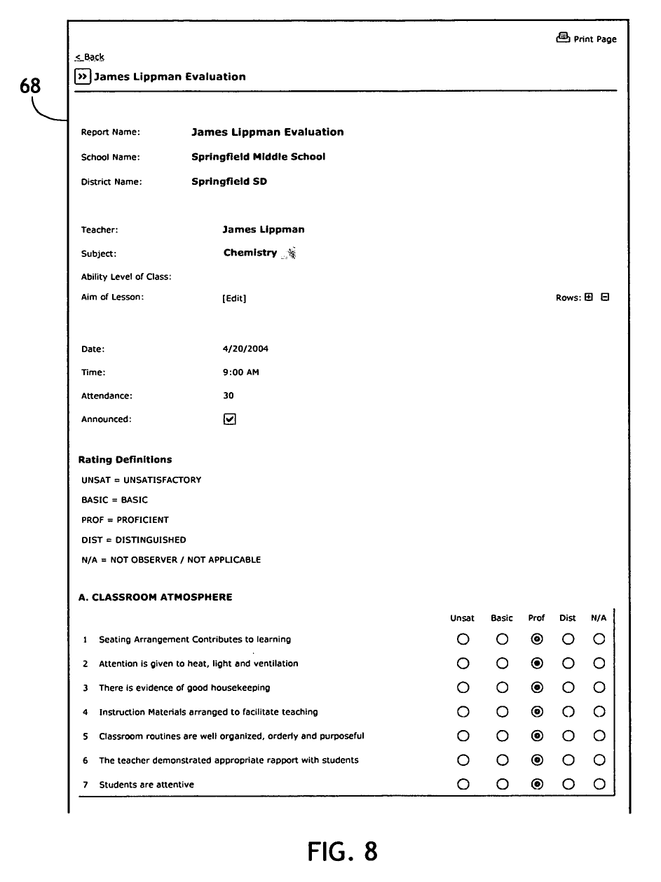

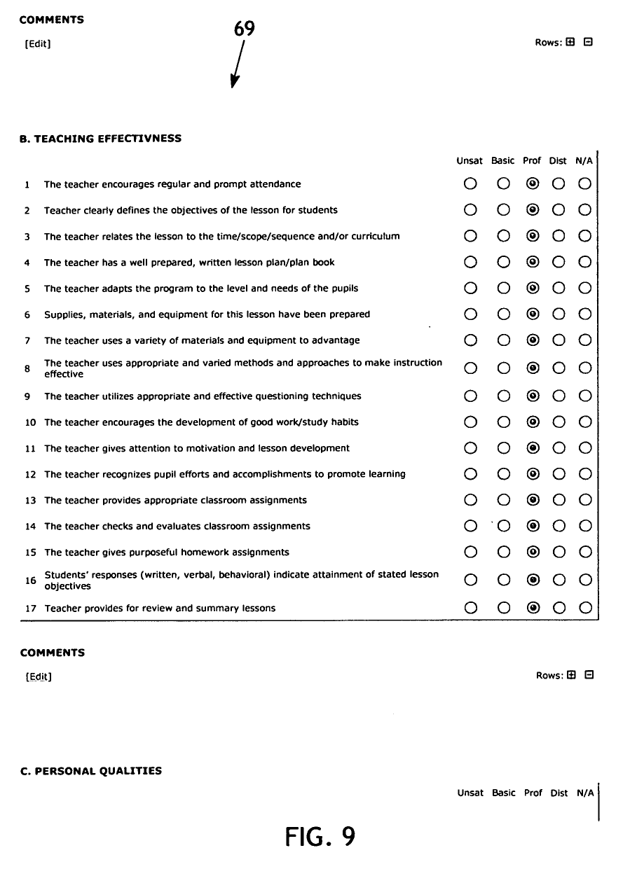

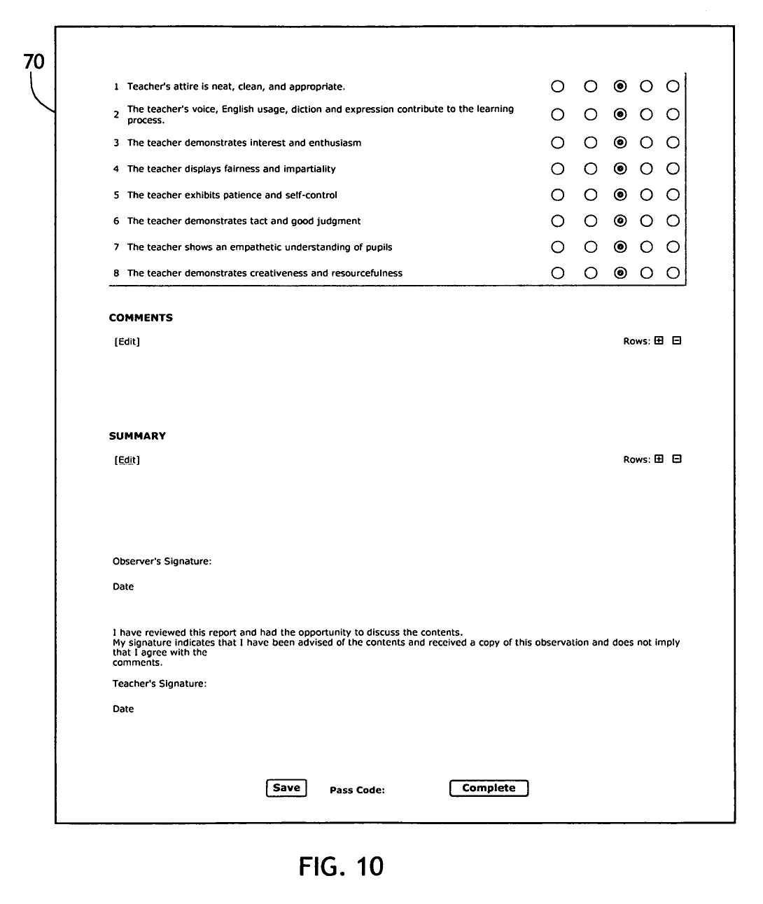

Screen 67 in FIG. 7 depicts an update evaluation form that displays and receives data regarding observation scheduling as well as pre- and post-observation meetings for one subject. FIG. 8 portrays screen display 68, which is the first page of a multi-page data input form that is used to carry out the actual observation and rating of the subject. Aside from identifying the individual being evaluated and the subject being taught and the date and time of the observation, it presents a series of criteria for judging the teaching performance, and includes multiple choice inputs for unsatisfactory, basic, proficient, distinguished, or not applicable ratings. The form continues in FIGS. 9 and 10 (screens 69 and 70), and includes sections on Classroom Atmosphere, and an entry window for related comments; Teaching Effectiveness and related comments; Personal Qualities and related comments.

The presentation of criteria for judging performance and the use of multiple choice entries simplifies and standardizes the evaluation, so that all individuals undergoing evaluation for a particular job description are subject to the same criteria for assessment by the evaluator. The performance ratings should be entered in real time while the evaluator observes the teacher's performance with a class. The comments fields permit observation notes and clarifications to be entered in real time also. This data may be stored in the evaluator's computer 33 and subsequently uploaded to the database server 37. Indeed, sensitive evaluation results may be stored, if desired, at the remote database server 37 and removed from the computer 33, so that no unauthorized individual at the evaluation site may gain access to such information.

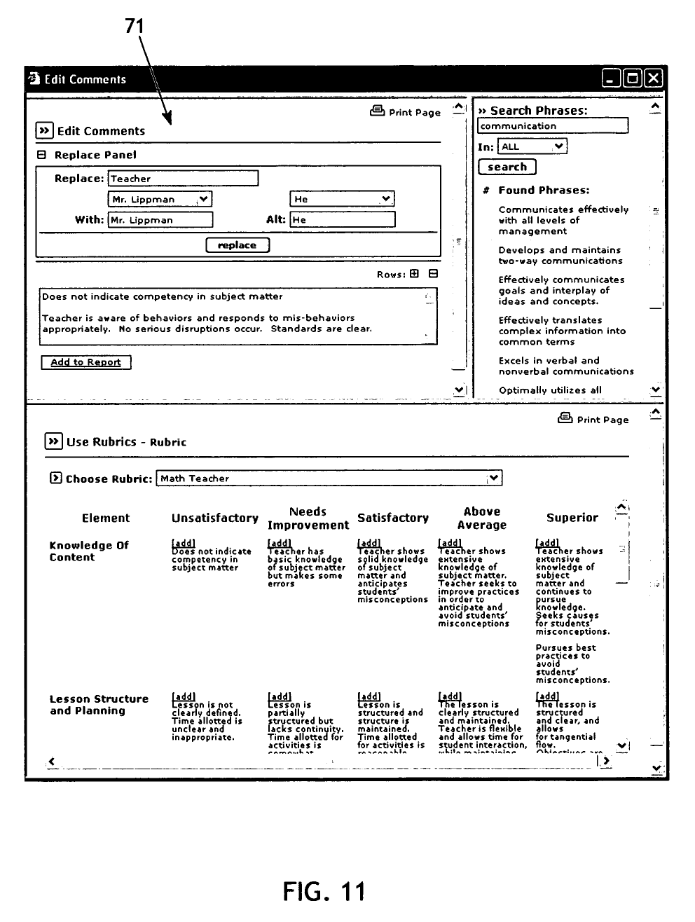

With regard to FIG. 11, another selection under the My School menu 54 is a screen 71 that provides a window for choosing a rubric that pertains to the job description of the person undergoing evaluation. In this context, a rubric is a set of declarative statements that are presented in tabular form, similar to a spreadsheet display, with each element of the evaluation form of FIGS. 8-10 presented vertically in the leftmost column, and each remaining column labeled with a multi-choice rating selection from the evaluation form. Each entry comprises a brief statement that expresses in declarative form the corresponding rating selection for the corresponding element. Each declarative statement is written in a subject-neutral form (“Teacher has basic knowledge . . . ”, etc.) The upper portion of screen 71 comprises a replacement panel in which the neutral term “teacher” may be designated for replacement by the correct gender pronoun (“he/his”, “she/her”, as well as substituting the name of the evaluation subject for “teacher”. It also includes a phrase library that contains expressions of evaluation, and is searchable by key word, topic, or the like. These phrases may be copied into a comments window and incorporated into the final evaluation report. Each job description has a rubric that is provided with an appropriate tabulation of statements, so that the evaluator may select suitable entries that are assembled into the final evaluation report.

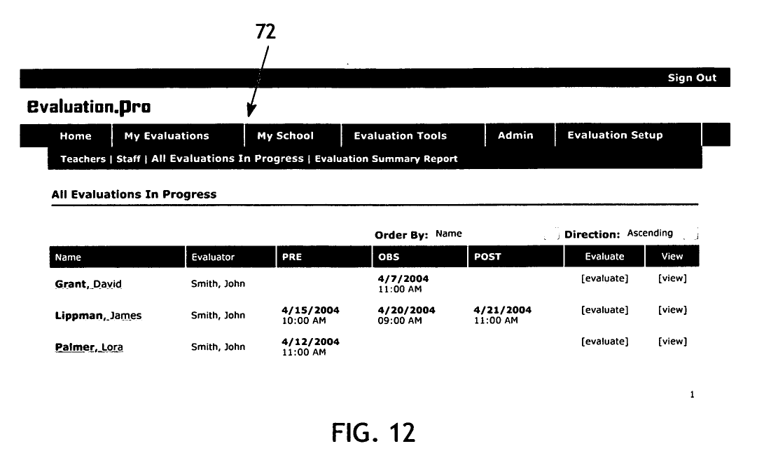

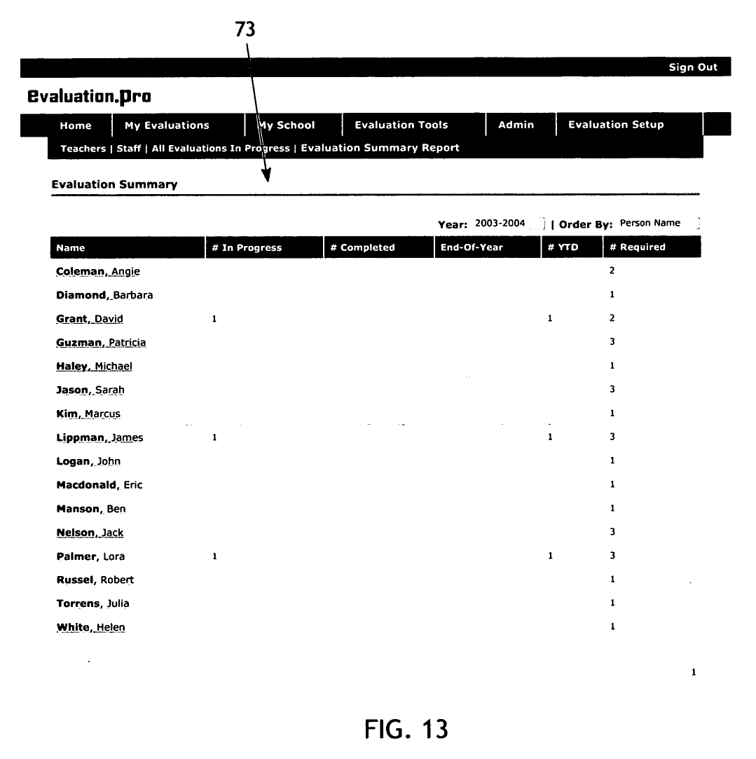

FIG. 12 shows another screen display 72 that is accessed from the My School menu 54, and presents a table of all evaluations in progress, including name of subject, evaluator, and times of meetings, as well as a click-through entry to the evaluation of each subject. FIG. 13 presents screen display 73, also accessed from My Schools menu, that charts all personnel, the number of evaluations required for each individual, and the status of ‘in progress’ and completed reviews. These screens 72 and 73 enable a personnel evaluator to arrange and keep track of evaluations of all personnel, including how many reviews are required per year for each job description, when reviews are scheduled, and pre- and post-observation meeting schedules.

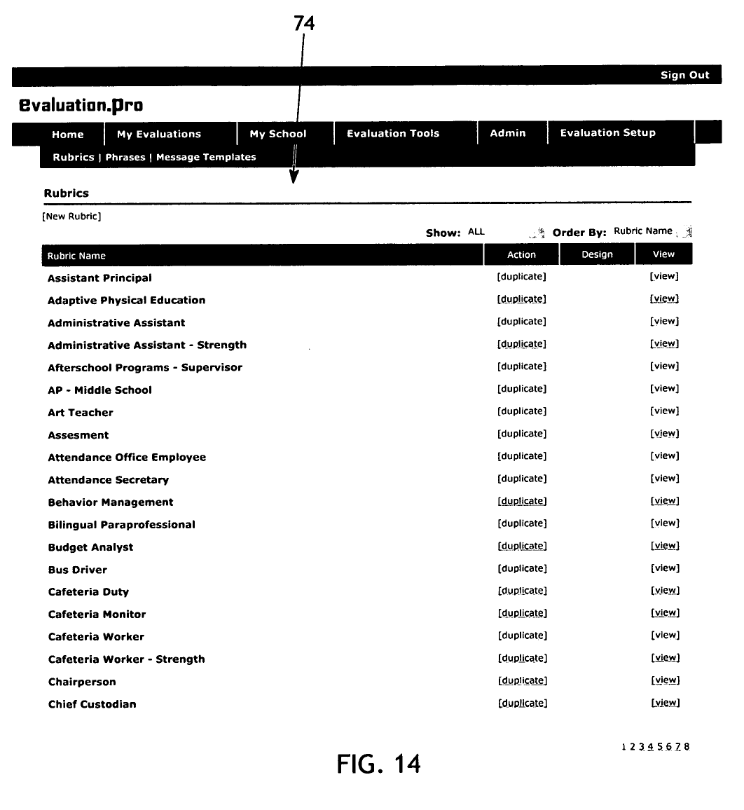

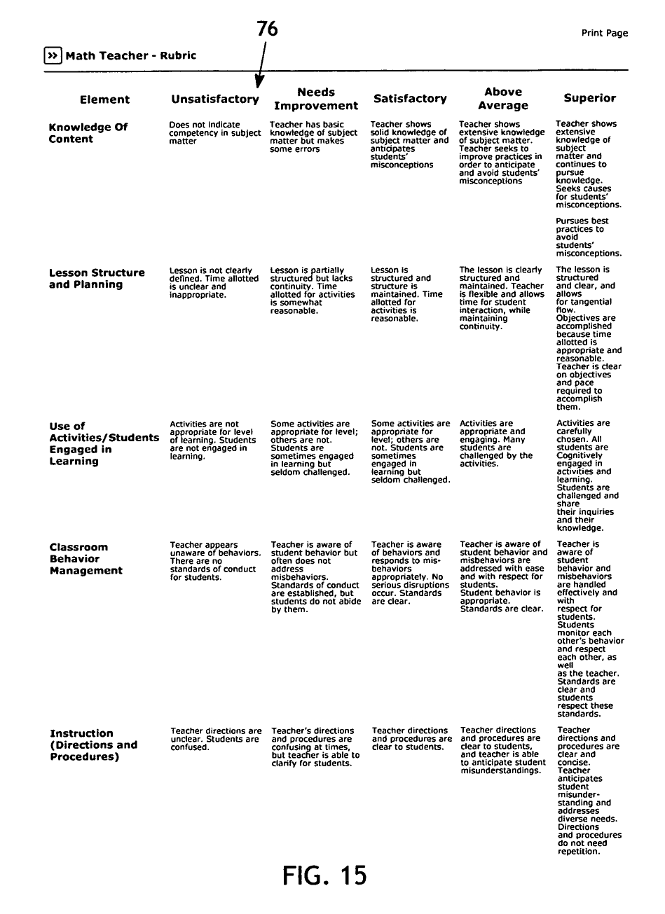

The Evaluation Tools menu 56 begins with screen 74, shown in FIG. 14, that displays a list of all of the rubrics available to the evaluator user. Note that the exemplary job descriptions range from various administrative positions to teacher to cafeteria duty and chief custodian, demonstrating that the evaluation system of the invention may be used for evaluation of a wide spectrum of job descriptions. Each rubric may be selected to be duplicated or viewed for possible use. Many pages of rubrics may be stored in memory and/or available through the internet connection to the online system database. Screen 76 of FIG. 15 depicts an example of a math teacher rubric selected from a list such as screen 74, and is a more complete chart corresponding to the rubric shown in FIG. 11.

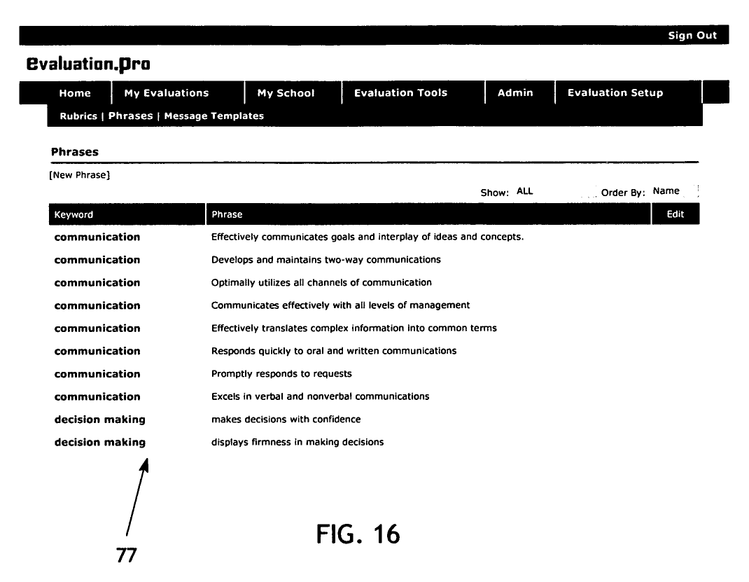

The Evaluation Tools menu 56 also provides a Phrases selection which leads to a phrase display as exemplified by screen 77 of FIG. 16. The user may input a key word to evoke a listing of phrases that pertain to the key word, so that the user may be self-prompted to employ the standard phraseology that is considered acceptable in evaluation reports. In the example of screen 77, a plurality of phrases relating to communications and decision making are displayed. This display may be evoked by use of the Search Phrases box that accepts key word inputs and displays a plurality of scrollable results as shown, for example, in FIG. 11, upper right corner of screen 71.

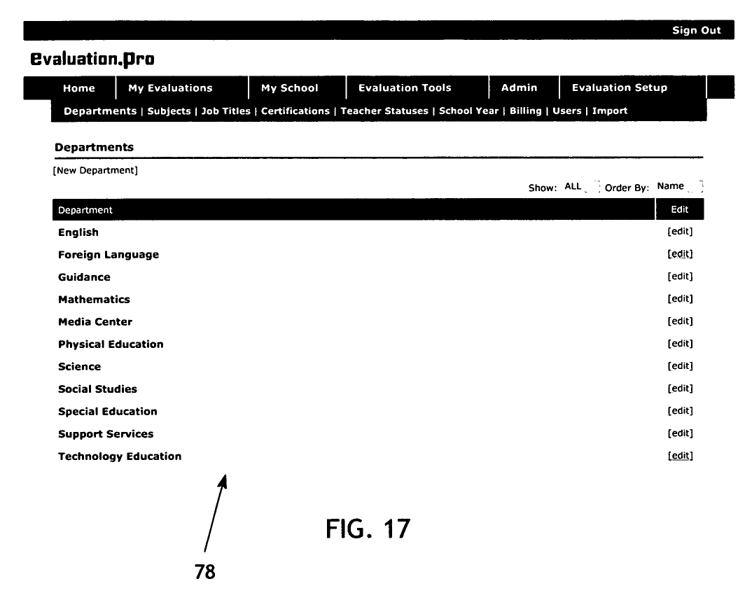

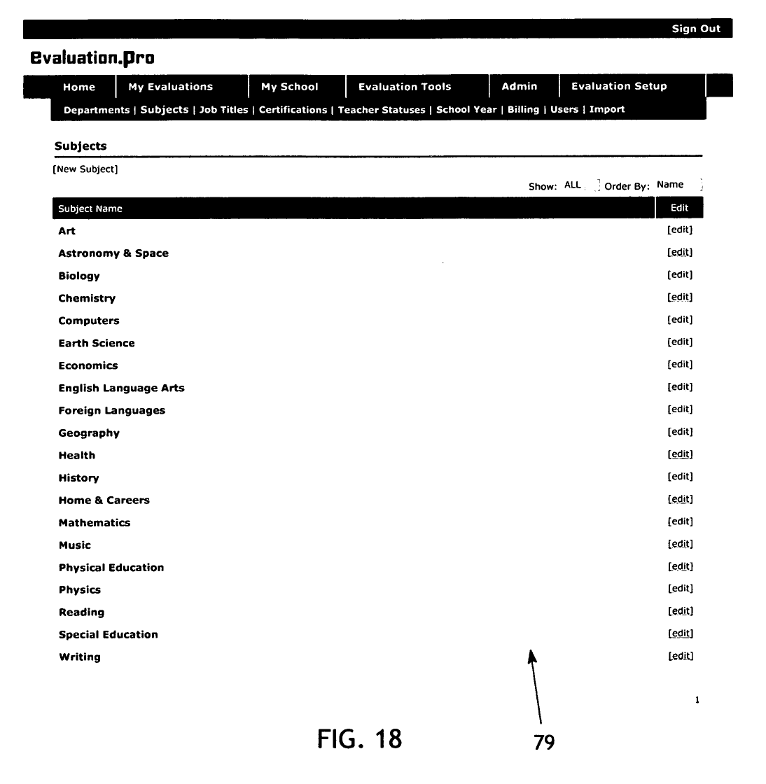

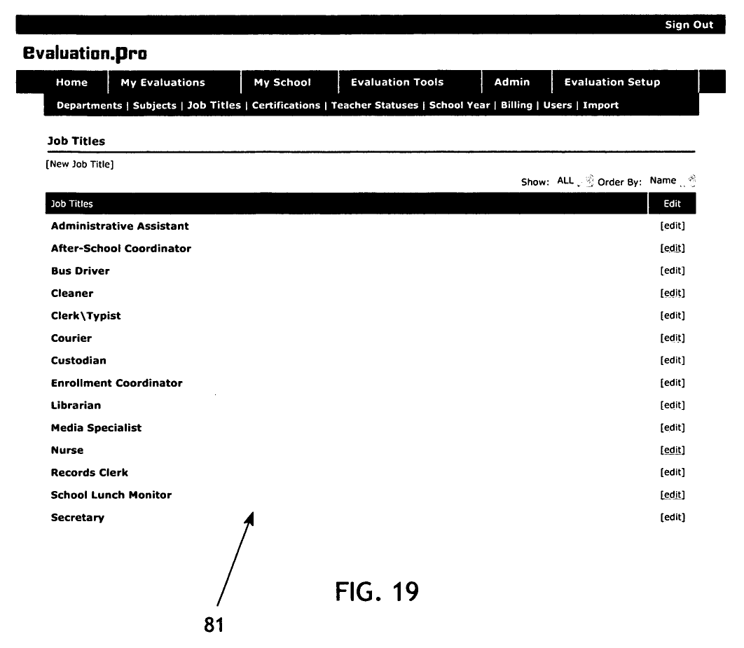

The Admin menu 57 begins with a Departments screen 78 (FIG. 17) that lists each organizational unit in the organization; in this example screen the units comprising educational and service departments of a school. This screen provides an active button for each department that enables editing of the evaluations status screen for each department. The evaluations data for all personnel may be accessed by a Subjects screen 79, shown in FIG. 18, with each subject having an active button for editing evaluations according to the subject being taught. Likewise, the evaluations data for all personnel may be accessed by a Job Titles screen 81, shown in FIG. 19, with each job title having an active button for accessing and editing evaluations of all personnel having the corresponding job title.

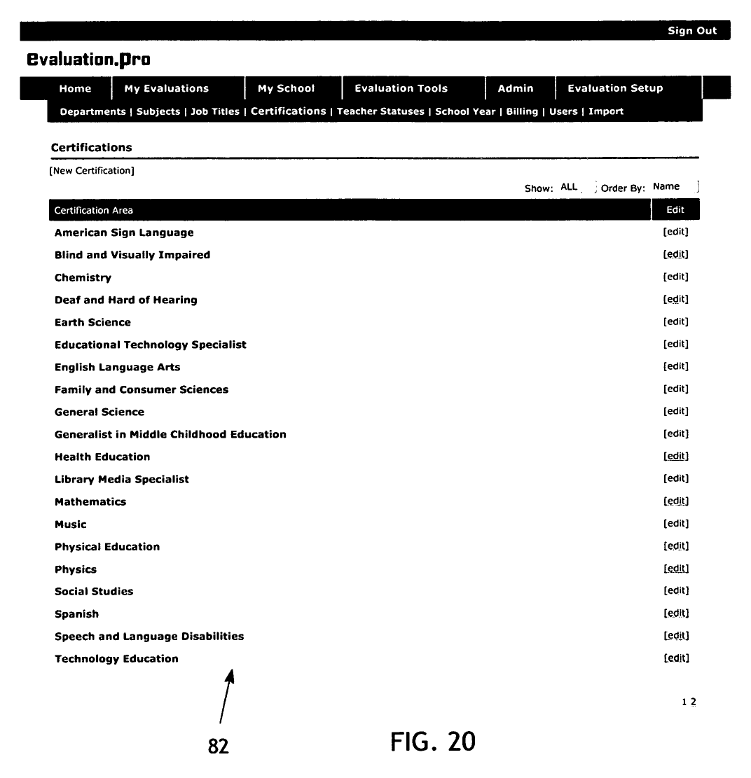

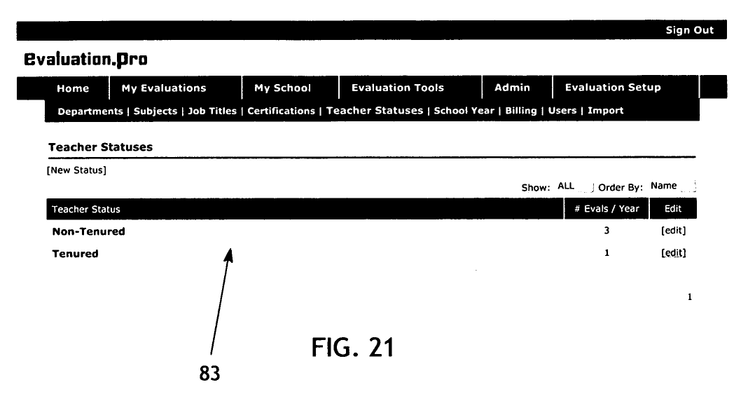

The Admin menu 57 also includes a Certification selection, which leads to screen 82 of FIG. 20. Screen 82 provides a list of all special skills certification programs available to the personnel at the school, certifications that require a specialized evaluation pertaining to advanced skills within the certification area. Each certification program has an active button for clicking through to a listing of all evaluations related to the respective certification topic. Screen 83 of FIG. 21 is another entry under the Admin menu, and presents evaluation data according to Teacher Status (i.e., new hire, probationary, etc.) or Tenure/Non-Tenure status. The corresponding active button enables the user to access evaluations data according these status categories and the personnel to whom they are relevant. This screen also apprises the evaluator user of the number of evaluations required per year based on the indicated employee status.

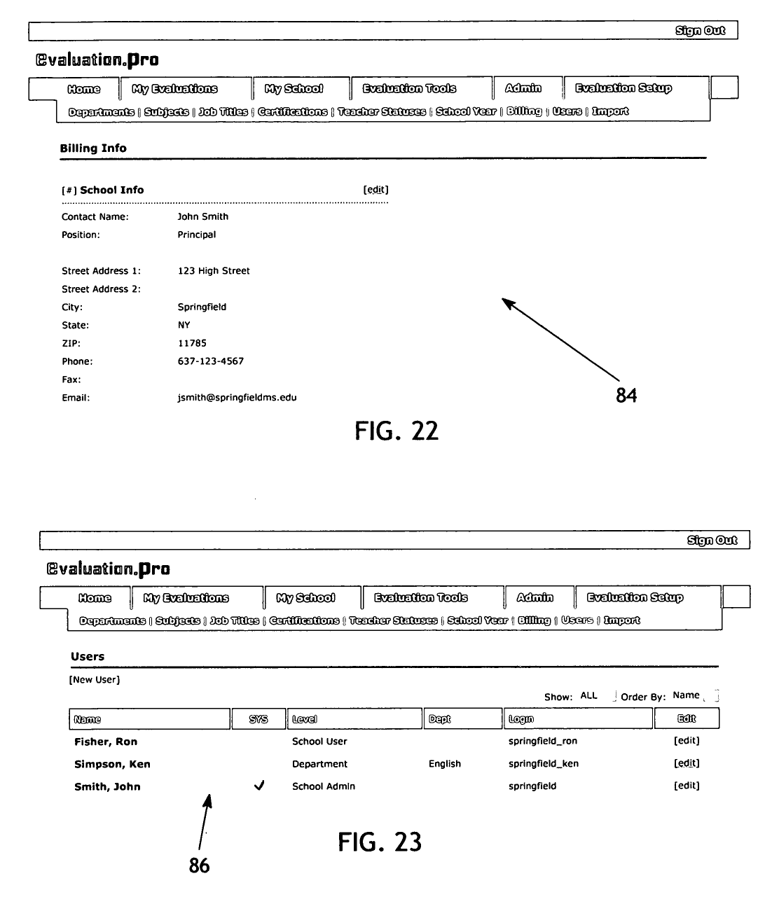

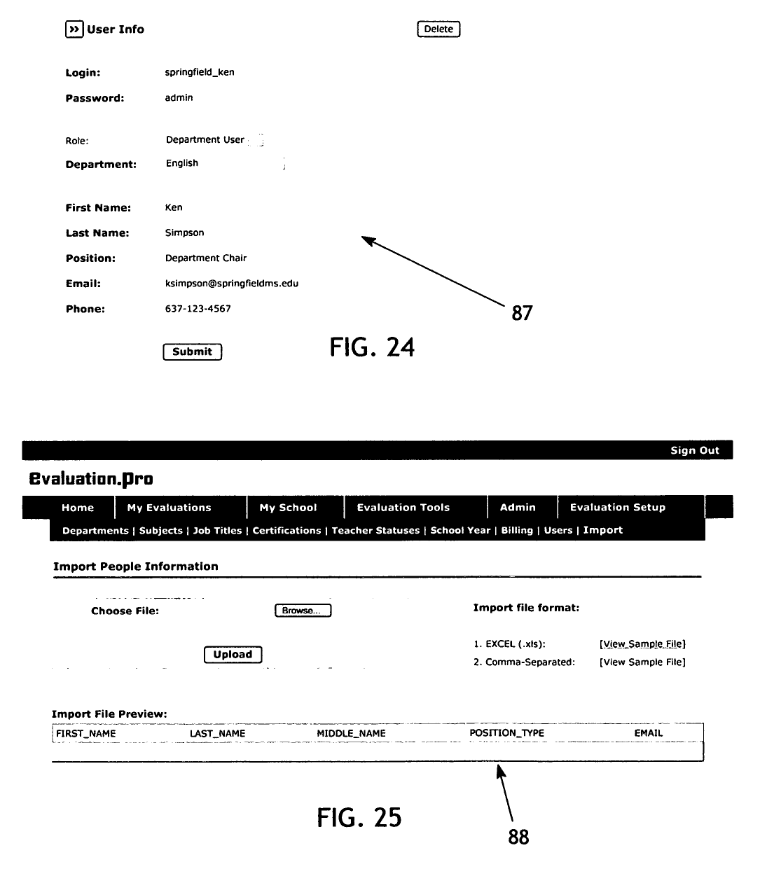

The Admin menu 57 also has a Billing selection which leads to screen 84 (FIG. 22) that displays the Billing contact data for any particular evaluation or organization. It also has a Users screen 86 (FIG. 23 that lists all the authorized evaluator/users, and indicates their level, department, and login. Each entry has an active Edit button that leads to screen 87 (FIG. 24) in which the user data may be input or revised or deleted. Admin menu 57 further includes an Import screen 88 (FIG. 25) that enables a user to import personnel files based on user input of name, position, certifications, and the like.

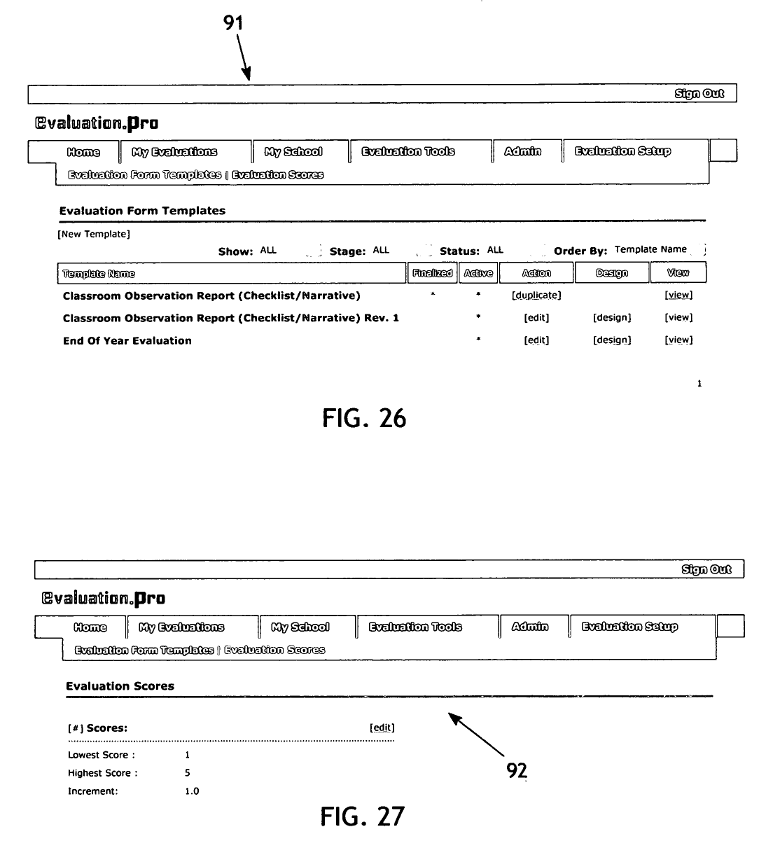

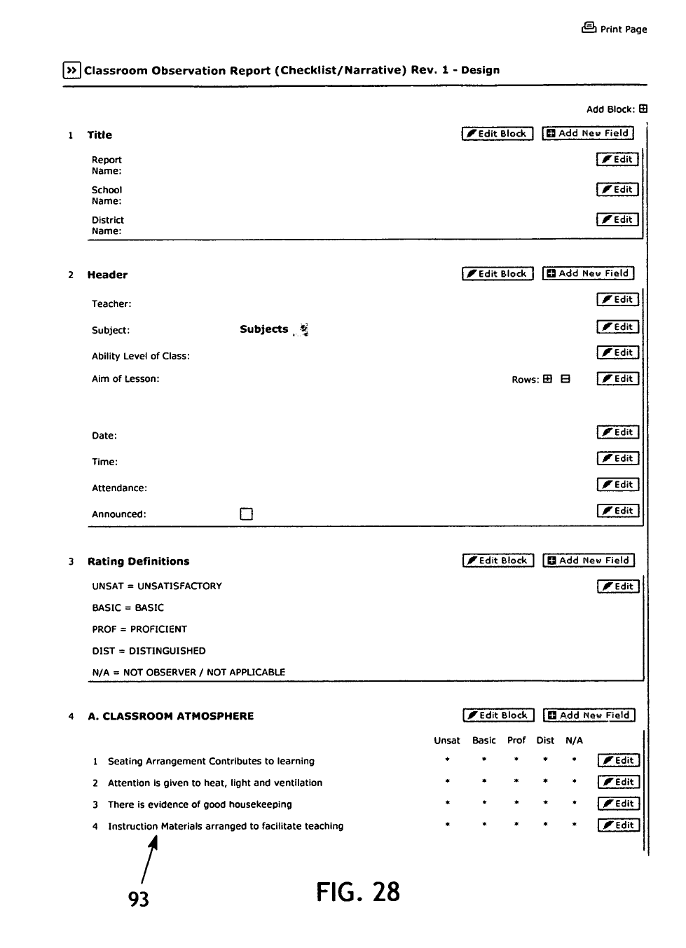

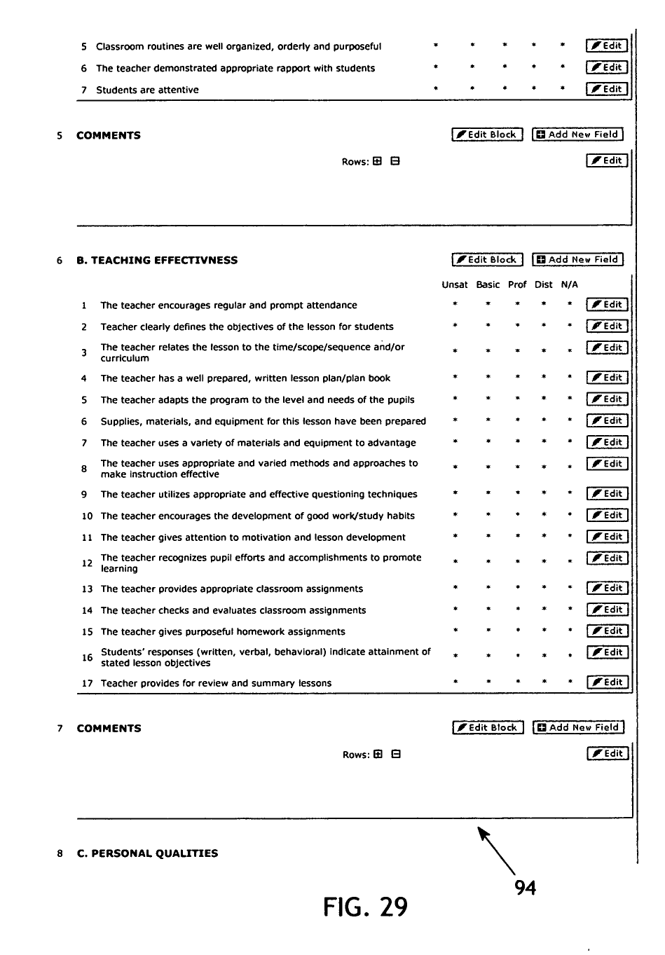

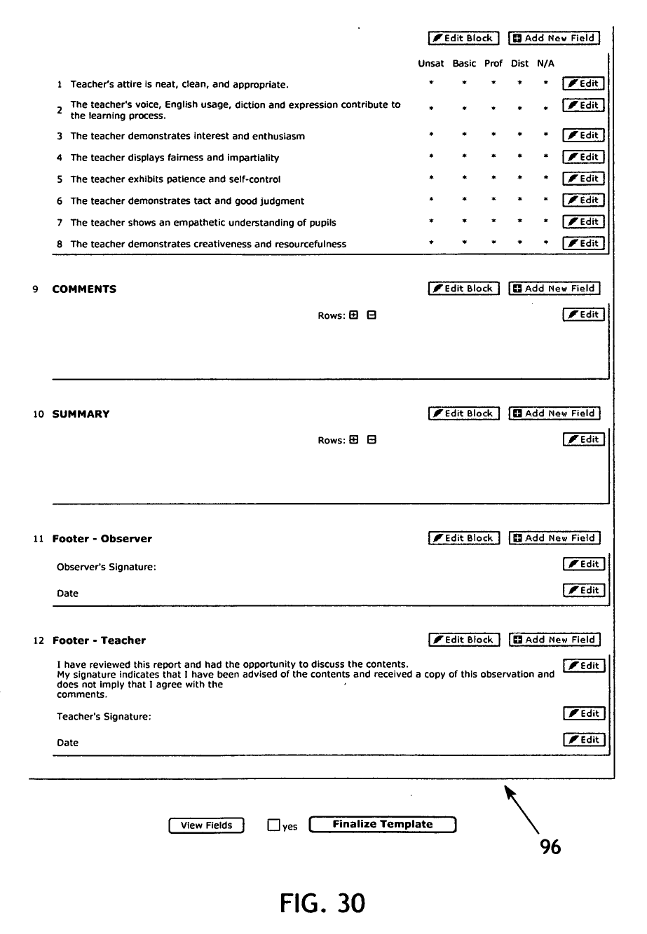

Screen 91 of FIG. 26 exemplifies the Evaluation Form Templates display that is accessed under the Evaluation Setup menu 58. This screen lists a plurality of evaluation templates based on subject, certification, and the like, and includes entries that indicate the Active and Finalized status of the templates, as well as their design status. It also enables the user to view, edit, or duplicate any template. Screen 91 enables the evaluator user to select the proper template for any scheduled evaluation and incorporate that template into the evaluation. This screen also enables the user to revise and save any previous evaluation for later use. Screens 93-96 of FIGS. 28-30 depicts an example of a multi-page display if the user were to select Classroom Observation . . . Rev. 1 and click the Design selection. Screen 93-96 provide active fields and edit buttons for every entry, including title, heading, and personal data, multiple choices for ratings input regarding blocks of rubric-oriented evaluation criteria, comments sections for direct evaluator input, and the like. As shown in FIG. 30, the finished template may be finalized and saved with a unique file name for future use or reference.

All of the active input blocks within each template are data collection points in the display, and the entries by the evaluator user are saved in a data file that correlates all rating entries with their respective evaluation, rating criteria, and comments entries of the template. Any active input block may be edited, added, or removed during the template design process.

Evaluation Setup menu 58 also presents an Evaluation Scores screen 92 (FIG. 27) that displays scores of evaluations undertaken within the active evaluations group.

The software includes report assembly modules that employ the user's checklist entries and comments, which may be recalled and the rubric entries are substituted for at least some of the entries. For example, it would be prudent to include a declarative sentence stating any negative rating entry, so that the terms of the negative evaluation are stated clearly using language that has been found to be acceptable in such evaluations. Thus the software application not only presents the evaluation criteria as a prompt to the evaluator, and gathers the prompted data inputs, but it also uses the proper terminology and jargon and syntax in assembling the report. In addition, the software asks for the gender of the evaluation subject and reformats the personal pronoun in the report sentences to reflect the correct gender of the subject (she/he, her/his, etc.).

Thus, for example, an evaluation that employs the rubric of FIG. 15 and finds the teacher (substituted as Ms. Smith/her) “needs improvement” in Knowledge of Content, is “satisfactory” in Lesson Structure and Planning, and “above average” in Use of Activities/ . . . Learning, could include the following text assembled automatically from the rubric entries by the software: “Ms Smith has basic knowledge of subject matter but makes some errors. Her lesson plan is structured and the structure is maintained. The time allotted for activities is reasonable. Activities are appropriate and engaging. Many students are challenged by the activities. . . . ” Comments written contemporaneously by the evaluator user during a review may be incorporated seamless into the text.

FIG. 31 displays screen 97, which is an example of a completed written evaluation produced by the software of the invention using data and comments entered by the reviewer, as well as rubric-based declarative sentences. At least some of the multiple choice rating entries are explicated by full sentences placed in the evaluation report by the software. The written evaluation report generated by the software saves the evaluator a great amount of time in report preparation, in that only a final edit by the reviewer is necessary.

Practical experience has shown that teacher evaluations carried out with the present invention require about one-third less time to complete when compared to traditional methods of teacher evaluations. The evaluations are superior to prior art traditional evaluations because of the sheer consistency of measurement, based on the rubrics set by the school district or administrative authority. The invention provides administrators with convenient online evaluation templates to easily complete teacher evaluations. The customizable templates come complete with specific educational Rubrics for each observation area, ready to be checked off in real observation time with the simple click of the mouse. Once the evaluation is complete the software effortlessly compiles a final thorough, personalized written analysis of the observation. All records are them automatically stored and easily retrieved in a convenient database to refer to or modify later.

All rubrics, forms and profiles can be completely and easily personalized to reflect the unique goals of each school district, therefore enabling the system to grow and adapt to evolving standards and issues. The web-based system of the invention offers the unique and invaluable feature of allowing participating school districts to compare philosophies, rubrics, and methods of observation, as well as offering technical assistance to ensure maximum ease and convenient usability. It standardizes and streamlines the process of classroom observations so that teachers will know specifically what is expected of them and how to conform to the goals of the district. Rubrics may be readily available for teachers to review and adhere to, thus avoiding inconsistency and unawareness while offering teachers the same performance tools they are expected to offer their students. Teachers will also benefit by having administrators with more time to meet their needs. Additionally, teachers will have access to their own profiles and observations online.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A system for facilitating and conducting personnel performance evaluations, including:
a computer for use by an evaluator user during a personnel performance evaluation, including a graphical user interface (GUI), an alphanumeric keyboard, processor, memory, and a pointing and navigating device for interactive use with said GUI;
software means operable on said computer to present a plurality of screen displays to an evaluator user during a personnel performance evaluation, each screen display including at least one of the following content components: personal data of the individual undergoing performance evaluation; at least one evaluation template having performance criteria and checklist entries for entering rating scores for each performance criterion; each screen display including active screen areas for accepting inputs from said keyboard and navigating device by said evaluator user;
database means for saving all said inputs from said evaluator user; and,
said software means further including means for assembling said inputs from said evaluator user into a written evaluation report for each personnel performance evaluation.

2. The system for personnel performance evaluations of claim 1, wherein said plurality of screen displays includes at least one page for editing said personal data and templates prior to use in a personnel performance evaluation.

3. The system for personnel performance evaluations of claim 1, wherein said plurality of screen displays includes at least one page for scheduling and calendaring planned personnel performance evaluations.

4. The system for personnel performance evaluations of claim 3, wherein said at least one page for scheduling and calendaring includes at least one page for setting a pre-observation and post-observation meeting with an evaluation subject.

5. The system for personnel performance evaluations of claim 1, further including a plurality of rubrics, each rubric directed to a respective job description, and means for incorporating any selected rubric into said at least one evaluation template.

6. The system for personnel performance evaluations of claim 5, wherein each rubric comprises a set of criteria for judging the performance of the individual undergoing evaluation for the respective job description, whereby the evaluation user is prompted to consider the set of criteria in making the evaluation.

7. The system for personnel performance evaluations of claim 6, wherein each rubric further includes a screen display having a plurality of declarative statements that are presented in matrix format, each criterion of said set of criteria presented in rows stacked vertically in one column, each remaining column labeled with a multi-choice ranking for the respective criterion, and each entry of the matrix format comprising a brief statement that expresses in declarative form the corresponding ranking selection for the corresponding criterion.

8. The system for personnel performance evaluations of claim 7, wherein said software means further includes means for extracting at least one of said brief statement entries corresponding to a ranking selection, and placing said at least one brief statement entry in said written evaluation report.

9. The system for personnel performance evaluations of claim 8, further including a screen display for accepting name and gender pronouns for the individual undergoing performance evaluation, said software means including means for placing the name and gender pronoun words into said at least one brief statement entry in said written evaluation report.

10. The system for personnel performance evaluations of claim 1, further including a plurality of evaluation templates, each template directed to a respective evaluation task, and said software means providing at least one screen display for selecting and modifying said plurality of evaluation templates.

11. The system for personnel performance evaluations of claim 10, further including a plurality of rubrics, each rubric directed to a respective job description, and said software means providing at least one screen display for selecting and incorporating any selected rubric into any of said plurality of evaluation templates.

12. The system for personnel performance evaluations of claim 11,
wherein each rubric comprises a set of criteria for judging the performance of the individual undergoing evaluation for the respective job description, whereby the evaluation user is prompted to consider the set of criteria in making the evaluation.

13. The system for personnel performance evaluations of claim 1, further including means for connecting said computer to a web-based network, said database means including a database portion stored remotely from said computer and accessible through said web-based network.

14. The system for personnel performance evaluations of claim 1, further including a plurality of templates stored remotely from said computer and accessible through said web-based network.

15. The system for personnel performance evaluations of claim 1, wherein said personal data is stored remotely from said computer and accessible through said web-based network.

16. The system for personnel performance evaluations of claim 1, wherein said means for assembling a written evaluation is stored remotely from said computer and accessible through said web-based network.

17. The system for personnel performance evaluations of claim 1, further including a phrase library, and said software means includes at least one screen display for presenting phrases sorted by topic or word, said phrases being selectable for incorporation into said written evaluation.
